(19) United States
(12) Patent Application Publication
(10) Pub. No.: US 2005/0233139 A1
(43) Pub. Date: Oct. 20, 2005

(54) Foamed contact adhesives

(75) Inventors: Stephan Zollner, Hamburg (DE); Marc Husemann, Hamburg (DE)

Correspondence Address: NORRIS, MCLAUGHLIN & MARCUS, PA, 875 THIRD STREET, 18TH FLOOR, NEW YORK, NY, 10022, US

(73) Assignee: TESA AG, HAMBURG (DE)

(21) Appl. No.: 10/514,134

(22) PCT Filed: Apr. 25, 2003
(86) PCT No.: PCT/EP03/04319

§ 371 Date: May 24, 2005

(30) Foreign Application Priority Data
May 11, 2002 (DE) 102 21 092.6

(51) Int. Cl. C08J 9/00; B32B 7/12

(52) U.S. Cl. 428/345; 521/50

(57) ABSTRACT

A process for preparing a pressure-sensitive adhesive, wherein first of all a hotmelt pressure-sensitive adhesive is prepared by a method known per se, characterized in that the hotmelt pressure-sensitive adhesive is foamed, the foamed hotmelt pressure-sensitive adhesive is placed onto a coolable roll, and crosslinking takes place on the coolable roll by exposure to actinic radiation.

For pressure-sensitive adhesive (PSA) foams there exist a multiplicity of applications. Thus PSA tapes based on PSA foams find application in automobiles, boats, aircraft, in home building, in the electrical sector, and for joining mechanical parts.

An advantage of such PSA tapes is the high bond strength in conjunction with high internal cohesion. Additionally these PSA tape types are very well able to compensate unevennesses on the substrates to be bonded. Since these PSA tapes are used very frequently in the industrial sector use is made in many cases of acrylate foams, since these foams for many purposes have desired or required specific advantages, such as, for example, aging stability and high internal cohesion, even at high temperatures.

One method of producing such foams is by adding what are called microbubbles to the monomers or to a prepolymer; the addition is followed by polymerization and/or crosslinking. This method is described for example in publications U.S. Pat. No. 4,726,982, U.S. Pat. No. 5,308,887, U.S. Pat. No. 5,658,630 and JP 17030/1982. In these cases microbubbles with a volume fraction of up to 60% are added to PSAs and in that way foams are produced.

As well as clear microbubbles use may also be made of colored versions. JP 272251/1986 and 237176/1991 describe such versions, the polymerization of the monomers being initiated there in turn by means of UV light.

Another addition which can be used besides microbubbles is glass dust (JP 49415/1994).

The methods described above are a simple method of producing foams, but the addition of the microbubbles results in a change in properties as compared with those of conventional foams. Moreover these microbubbles are likewise more costly than, say, air as a foaming aid.

Besides the methods described above there exist other possibilities of incorporating air bubbles into the PSAs. JP 58369/1983, for example, uses urea-based foaming reagents. In that case the PSA is in the form of an aqueous dispersion, and foaming is initiated thermally.

In JP 89585/1988 a dispersion is foamed by vigorous stirring. In that sense JP 45184/992 describes the production of open cells in the foam by vigorous stirring of acrylate dispersions and also the production of closed cells by reaction with a foaming reagent, through the thermal drying operation.

In JP 186744/1993 an acrylate dispersion and a urethane dispersion are mixed for foaming.

In JP 304170/1989 acrylate monomers, epoxy resins and acrylate resins are foamed in emulsion and then dried thermally.

In JP 201320/1989 low molecular mass acrylate copolymers are reacted with polyfunctional polyisocyanates under conditions such that readily volatile constituents are formed which initiate a foaming process.

In the foregoing publications a multiplicity of foaming compounds are added which undergo thermal reaction to release readily volatile constituents and therefore bring about the foaming of the PSA tape. This principle can be employed very effectively for coatings from dispersions or from solution. For coating from the melt, however, the methods described above are unsuitable, since the foam would otherwise come about as early as during hotmelt processing. Hotmelt processes are preferable on economic and environmental grounds as polymerization and processing operations, since the fraction of solvent is greatly reduced and, furthermore, high operating speeds can be realized.

U.S. Pat. No. 5,753,362, in contrast, describes a number of methods of producing air bubbles within foams. In the case of methods of this kind, however, a problem frequently occurs in the polymer matrix, since the foams produced by air bubbles tend to collapse again. Therefore PMMA, for example, is used as the polymer matrix. This material, however, possesses a very high glass transition temperature and does not exhibit PSA properties.

As filler materials for PSA foams it is possible to use hollow glass beads: methods of that kind are described for example in publications JP 49766/1983, JP 64682/1984 and 90028/1995.

In WO 95/01408 specific elastomers based on block copolymers are prepared. In that case, however, only elastomers can be used. This process is unsuitable for viscoelastic PSAs, since the PSA would coalesce after the foaming operation, and is unstable.

EP 0 901 357 describes backing materials with a partial self-adhesive coating, and also a process for producing them. In that process PSAs are foamed in the melt with gases or air and then coated. This process, however, has the disadvantage that polyacrylate foams in particular collapse in on themselves again as a result of the rheology. The process is therefore not suitable for very fluid systems, which are coated with particular preference by hotmelt processes.

It is therefore an object of the invention to provide a process which allows PSA foams to be stabilized without exhibiting the disadvantages of the prior art. The intention in particular is to prevent the PSA foams shrinking significantly, recompacting or collapsing in on themselves in the course of stabilization.

This object is achieved by a process as specified in the claims. Thus it was found, surprisingly and unforeseeably for the skilled worker, that the foams do not fall in on themselves, instead retaining their foam structure, if the foam, in the course of crosslinking by actinic radiation, runs over a cooled roll, especially when there is a contact medium between the roll and the foam.

Accordingly, claim 1 provides a process for preparing a pressure-sensitive adhesive which involves first preparing a hotmelt pressure-sensitive adhesive by a conventional method, wherein further the hotmelt pressure-sensitive adhesive is foamed, the foamed hotmelt pressure-sensitive adhesive is placed on a coolable roll (chill roll) and is crosslinked on the coolable roll by exposure to actinic radiation.

Foaming may in this case likewise be carried out by a conventional method.

The foamed hotmelt pressure-sensitive adhesive can be placed onto the roll in one or more layers.

In one preferred embodiment the crosslinked PSA foam is transferred to a backing material and/or to a further PSA layer.

Advantageously the hotmelt PSA is crosslinked by exposure to electron beams or to UV radiation.

Typical irradiation equipment for crosslinking by means of electron beams comprises linear cathode systems, scanner systems or segmented cathode systems, where the apparatus in question comprises electron beam accelerators. A detailed description of the state of the art and of the most important process parameters is given in Skelhorne “Electron Beam Processing” in Vol. 1 “Chemistry & Technology of UV & EB Formulations for Coatings, Inks & Paints”, published by Sita Technology, London 1991.

The acceleration voltages are advantageously in the range between 40 kV and 500 kV, preferably between 80 kV and 300 kV. The radiation doses employed range between 5 and 150 kGy, in particular between 20 and 100 kGy.

Alternatively or additionally the crosslinking may be carried out by means of UV radiation, in particular by means of brief ultraviolet irradiation in a wavelength range from 200 to 450 nm, especially using high-pressure or medium-pressure mercury lamps, at an output of 80 to 240 W/cm. For UV crosslinking it is also possible, however, to use monochromatic radiation in the form of laser light. In order to prevent instances of overheating it may be appropriate to shade off part of the UV beam path. Additionally it is possible to use special reflector systems which function as cold-light emitters, so as to prevent instances of overheating.

In the case of irradiation using a chill roll it is possible to select significantly higher radiation doses, which are necessary for crosslinking, than in the case of conventional crosslinking techniques.

In one preferred embodiment the roll is actively cooled during irradiation of the hotmelt PSA. In particular it is advantageous if the temperature of the roll during irradiation is not more than 25° C.

For this purpose it is advantageous if the roll is actively cooled.

As the chill roll it is common to use a grounded metal roll that absorbs the electrons which impinge, in the case of crosslinking by electron beams, and absorbs the resultant X-radiation. The roll must be equipped with an effective cooling system in order to carry off the considerable quantities of heat. In order to prevent corrosion this roll is commonly coated with a protective layer. Said layer is preferably selected such that it is effectively wetted by the contact medium. In general the surface is electrically and/or thermally conductive. It may, however, also be more advantageous to coat the roll with one or more layers of insulating or semiconducting material. Moreover the cooling function ought to be very pronounced, in order to stabilize the PSA foam. In one preferred procedure, therefore, cooling takes place to temperatures below 25° C., in one very preferred procedure to temperatures below 5° C.

The chill roll may be macroscopically smooth or else may have a slightly structured surface. It has proven appropriate for there to be a surface structure present, in particular a roughening of the surface. This facilitates wetting of the surface.

Furthermore it is very advantageous if during irradiation of the hotmelt PSA there is a contact medium present between the adhesive and the roll. The contact medium may be applied to the reverse of the PSA foam and/or to the roll; alternatively or additionally it is possible to apply the contact medium contactlessly, such as by spray application, for example.

The contact medium here may be a material which is capable of producing contact between the PSA and the roll surface, in particular a material which fills the cavities between the PSA and the roll surface (unevennesses in the roll surface or bubbles, for example).

If desired there may also be a backing material present between the PSA and the roll surface, or such a backing material may be introduced into the system by means, for example, of coextrusion. In that case, however, the backing material should preferably possess a very good thermal conductivity, so that sufficient heat can be taken off from the foamed hotmelt through the backing material onto the roll.

Advantageously it is possible to use, as the contact medium, flowable materials which can be used within a wide viscosity range. Thus the contact medium, for example, may itself be composed of a PSA or else of another material which flows onto the roll and/or onto the underside of the foamed PSA layer lying on it and displaces the air between the foamed PSA layer and the roll.

Additionally it is possible to use soft, “conforming” materials as the contact medium. On the one hand it is possible with preference to use soft-elastic materials, such as soft rubber, plasticized PVC, other plasticized polymers and similar materials, for example. If these are firmly joined to the chill roll, they must possess sufficient radiation stability and also have sufficient thermal and electrical conductivity.

It is particularly advantageous not to leave the contact medium permanently on the roll but instead to apply it to the roll before the irradiation operation and to remove it from the roll again after the irradiation operation. In one further advantageous embodiment the contact medium is in the form of a replaceable coating on the roll. The contact medium can be changed during the irradiation operation (continuous change) or between the individual irradiation operations (discontinuous change). The continual replacement prevents the contact medium being so greatly impaired by the ongoing irradiation that it loses its function.

Advantageously the contact medium used comprise a liquid which, if desired, obtains additives for additional functions. These include increasing the wetting and electrical conductivity and also scavenging free radicals and other reactive species which are produced by the radiation absorbed.

As a contact liquid it is possible with advantage to use water, which meets the required functions. In a further version substances at least partly soluble in the contact medium are added to said medium. In the case of water as the contact medium appropriate additives include, for example, alkyl alkoxides such as ethanol, propanol, butanol and hexanol. Also very advantageous are, in particular, relatively long-chain alcohols, polyglycols, ketones, amines, carboxylates, sulfonates and the like.

Advantageous contact media possess a low surface tension. A reduction in the surface tension can be achieved by adding small amounts of nonionic and/or anionic and/or cationic surfactants to the contact medium. In the simplest case use may be made for this purpose of commercial rinse agents or soap solutions, preferably in a concentration of a few g/l in water as contact medium. Particular suitability is possessed by special surfactants, which can also be used at low concentration. Mention may be made here, for example, of sulfonium surfactants (e.g., β-di(hydroxyalkyl)sulfonium salt), and also for example of ethoxylated nonylphenyl-sulfonic acid ammonium salts. Reference may be made here in particular to the prior art under “surfactants” in Ullmann's Encyclopedia of Industrial Chemistry, sixth edition, 2000 Electronic Release, Wiley-VCH, Weinheim 2000.

As contact media it is also possible to use the aforementioned liquids without the addition of water, in each case alone or in combination, with one another.

To improve the properties of the contact medium (for example, to increase the shear resistance, reduce the transfer of surfactants or the like to the liner surface, and hence to provide improved cleaning possibilities for the end product) it is possible with advantage, additionally, to add salts, gels and similar viscosity-increasing additives to the contact medium and/or to the additives employed.

In the case of a liquid contact medium one possible outstanding procedure is that wherein a second roll, advantageously having a wettable or absorbent surface, runs through a bath containing the contact medium, in doing so is wetted or impregnated with the contact medium and, by contact with the chill roll, applies a film of said contact medium.

In accordance with the invention it is possible with great advantage, using the process presented here, to prepare and stabilize pressure-sensitive adhesives based on acrylate, natural rubber, synthetic rubber and/or EVA. The process is also applicable in principle to the production for the other radiation-crosslinkable PSAs known to the skilled worker, especially for those as listed for example in the “Handbook of Pressure Sensitive Adhesive Technology” by Donatas Satas (van Nostrand, New York 1989).

The foamed PSAs may with preference be acrylate-based PSAs. In that case it is possible with advantage to start from a monomer composition containing from 70% to 100% by weight of
a1) acrylic esters and/or methacrylic esters and/or the free acids thereof with the following general formula
   CH₂═CH(R₁)(COOR₂)
   where R₁=H or CH₃ and R₂=H or an alkyl chain having 1 to 30 carbon atoms and further from 0% to 30% by weight of
a2) olefinically unsaturated monomers containing functional groups, groups a1) and a2) adding up either to 100% by weight or to a figure smaller than 100%, in which case the monomer mixture contains further monomers.

In an advantageous procedure it is possible to add, as a further component a3), up to 20% by weight, preferably from 0.5 to 5% by weight, based in each case on the monomer composition, of polystyrene compounds functionalized terminally with at least one acrylate and/or methacrylate group, approximately in the sense of the molecules, stated in analogy to U.S. Pat. No. 4,551,388, of the general type 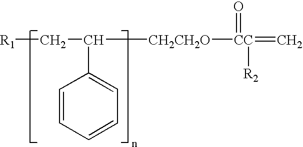
where R₂=H or CH₃. R₁ is a radical remaining from the polymerization initiator, preferably for example 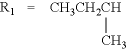
Macromonomers of this kind are sold commercially for example under the trade name Chemlink® 4500 (Sartomer) [R₁═CH₃CH₂CH(CH₃); R₂═CH₃] or Methacromer® PS12 (Polymer Chemistry Innovations) [R₁ unspecified, R₂═CH₃].

For the monomers of group a1) it is preferred to use acrylic and/or methacrylic esters with alkyl groups having 4 to 14 carbon atoms, preferably having 4 to 9 carbon atoms, examples being n-butyl acrylate, n-pentyl acrylate, n-hexyl acrylate, n-heptyl acrylate, n-octyl acrylate, n-nonyl acrylate, lauryl acrylate, stearyl acrylate and behenyl acrylate, the methacrylic acid derivatives of the aforementioned compounds, branched isomers of the aforementioned acrylic and methacrylic compounds (2-ethylhexyl acrylate, for example) and also methyl methacrylates, isobornyl acrylate and/or isobornyl methacrylates.

For the monomers of group a2) it is advantageous to make use for example of vinyl esters, vinyl ethers, vinyl halides, vinylidene halides, vinyl compounds with aromatic rings and heterocycles in a position; examples that may be mentioned of above groups include vinyl acetate, vinylformamide, vinylpyridine, ethyl vinyl ether, vinyl chloride, vinylidene chloride and/or acrylonitrile.

Additionally for a2) it is possible to use, with preference, monomers containing hydroxyl, carboxyl, epoxy, acid amide, isocyanato and/or amino groups.

As monomers of group a2) it is additionally possible with advantage to choose monomers which in addition to a polymerizable double bond contain at least one functional group that is capable of promoting a crosslinking reaction and/or has an H donor effect, examples being monomers in the form of the general formula CH₂═CH(R₃)(COOR₄), where R₃═H or CH₃ and the radical —OR₄ comprises or constitutes said functional group.

Very preferred examples of monomers of group a2) are, additionally, hydroxyethyl acrylate, hydroxypropyl acrylate, hydroxyethyl methacrylate, hydroxypropyl methacrylate, allyl alcohol, maleic anhydride, itaconic anhydride, itaconic acid, acrylamide, glyceridyl methacrylate, benzyl methacrylate, phenyl acrylate, phenyl methacrylate, t-butylphenyl acrylate, t-butylphenyl methacrylate, phenoxyethyl acrylate, phenoxyethyl methacrylate, 2-butoxyethyl acrylate, 2-butoxyethyl methacrylate, dimethylaminoethyl acrylate, dimethylaminoethyl methacrylate, dimethylaminomethyl acrylate, dimethylaminomethyl methacrylate, cyanoethyl acrylate, cyanoethyl methacrylate, glyceryl methacrylate, 6-hydroxyhexyl methacrylate, n-tert-butylacrylamide, N-methylolacrylamide, N-methylolmethacrylamide, N-(buthoxymethyl)methacrylamide, N-(ethoxymethyl)-acrylamide, N-isopropylacrylamide, vinylacetic acid, tetrahydrofurfuryl acrylate, β-acryloyloxypropionic acid, trichloroacrylic acid, fumaric acid, crotonic acid, aconitic acid and/or dimethylacrylic acid, this enumeration being only by way of example and not conclusive.

In a further advantageous procedure use is made as monomers a2) of aromatic vinyl compounds, in which case preferably the aromatic nuclei are composed of C₄ to C₁₈ structural units and may also contain heteroatoms. Particularly preferred examples are styrene, 4-vinylpyridine, N-phenylphthalamide, methylstyrene, 3,4-dimethoxystyrene and/or 4-vinylbenzoic acid, this enumeration as well being only by way of example and not conclusive.

For the polymerization the monomers are chosen and composed such that the resultant polyacrylates can be used as industrially useful PSAs, especially such that they possess PSA properties in accordance with the “Handbook of Pressure Sensitive Adhesive Technology” by Donatas Satas (van Nostrand, New York 1989). For these applications the statistical glass transition temperature of the resulting polyacrylate is advantageously below 25° C. (glass transition temperatures are quoted as results of quasistatic methods such as, for example, differential scanning calorimetry (DSC), constant heating rate 10° C. in 5 min, inert gas atmosphere).

The polymerization can be conducted by a conventional method or in modification of a conventional method, in particular by means of conventional free-radical polymerization and/or controlled free-radical polymerization; the latter is characterized by the presence of suitable control reagents.

The polymerization is conducted such that the resulting polymers preferably have average molecular weights Mₙ (number averages) in a range from 50 000 to 1 000 000 g/mol; specifically for further use as hotmelt PSAs preference is given to polymers having average molecular weights Mₙ of from 100 000 to 800 000 g/mol. The average molecular weight is determined by size exclusion chromatography (gel permeation chromatography, GPC) (eluent: THF with 0.1% by volume of trifluoroacetic acid; measurement temperature 25° C.; pre-column: PSS-SDV, 5μ, 10³ Å, ID 8.0 mm×50 mm; separation: columns PSS-SDV, 5μ, 10³ and also 10⁵ and 10⁶ each with ID 8.0 mm×300 mm; sample concentration 4 g/l, flow rate 1.0 ml/min; measurement against polystyrene standards) or matrix-assisted laser-desorption/ionization-mass spectrometry (MALDI-MS).

With advantage the polymers have a narrow molecular weight distribution (polydispersity D=M_{w}/Mₙ), preferably of D≦3, very preferably of D≦2. The polydispersity is determined likewise by way of GPC (measurement parameters as above).

The polymerization can be conducted in bulk, in the presence of one or more organic solvents, in the presence of water and/or in the presence of mixtures of one or more solvents with water. The aim is to minimize the amount of solvent used. As organic solvents it is possible with advantage to use pure alkanes (hexane, heptane, octane, isooctane, etc.), aromatic hydrocarbons (benzene, toluene, xylene, etc.), esters (ethyl, propyl, butyl and/or hexyl acetate, etc.), halogenated hydrocarbons (chlorobenzene etc.), alkanols (methanol, ethanol, ethylene glycol, ethylene glycol monomethyl ether, etc.) and/or ethers (diethyl ether, dibutyl ether, etc.). A water-miscible or hydrophilic cosolvent may be added to the aqueous polymerization reactions in order to ensure that the reaction mixture is in the form of a homogeneous phase during monomer conversion. Cosolvents which can be used with advantage include aliphatic alcohols, glycols, ethers, glycol ethers, pyrrolidines, N-alkylpyrrolidinones, N-alkylpyrrolidones, polyethylene glycols, polypropylene glycols, amides, carboxylic acids and also their hydrides and/or salts, esters, organic sulfides, sulfoxides, sulfones, alcohol derivatives, hydroxyether derivatives, amino alcohols, ketones and the like, and also derivatives of the aforementioned compounds, individually or in a mixture with one another.

The polymerization time, depending on conversion rate and temperature, is advantageously between 4 and 72 hours. The higher the reaction temperature that can be chosen, in other words the higher the thermal stability of the reaction mixture, the lower the level at which the reaction time can be chosen.

To initiate the polymerization it is essential, for the initiators which decompose thermally, that heat be introduced. The polymerization can be initiated for the thermally decomposing initiators by heating to 50 to 160° C., depending on initiator type.

After polymerization has taken place the polymers obtained are concentrated to a hotmelt PSA (polyacrylate hotmelt PSA) whose solvent content is ≦2% by weight, more preferably ≦0.5% by weight. This operation takes place preferably in a concentrating extruder.

For natural rubber adhesives the natural rubber is milled to a freely selectable molecular weight and treated with additives. It is also possible to employ electron-beam-crosslinkable or UV-crosslinkable synthetic rubber adhesives.

In the case of (synthetic) rubber as a starting material for the hotmelt PSA there are wide possibilities for variation. As a basis for the hotmelt PSA use is made advantageously of natural rubbers or synthetic rubbers or any desired blends of natural rubbers and/or synthetic rubbers, it being possible to select the natural rubber or rubbers in principle from all available grades such as, for example, crepe, RSS, ADS, TSR and/or CV types, depending on required purity and viscosity level, and the synthetic rubber or rubbers from the group consisting of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

Additionally it is possible to add thermoplastic elastomers, preferably with a weight fraction of from 10% to 50% by weight, based on the total elastomer fraction, to rubbers, preferably for improving the processing properties. Those that may be mentioned as representatives include in particular the specially compatible styrene-isoprene-styrene (SIS) and styrene-butadiene-styrene (SBS) types.

Advantageously the acrylate, natural- or synthetic-rubber or other PSAs are blended with at least one resin.

As tackifying resins it is possible to use all of the existing tackifier resins known, and those described in the literature, provided they exhibit at least partial compatibility (miscibility) with the PSA. Mention may be made by way of representation of the pinene resins, indene resins and rosins, their disproportionated, hydrogenated, polymerized and/or esterified derivatives and/or salts, the aliphatic and aromatic hydrocarbon resins, terpene resins and terphenol resins, and also C5-, C9- and other hydrocarbon resins.

The resins can be used individually, in combination with one another or else with further resins. The type and amount of the admixed resins may be guided by the desired properties of the resultant PSA. Express reference may be made to the depiction of the state of the art in the “Handbook of Pressure Sensitive Adhesive Technology” by Donatas Satas (van Nostrand, 1989).

Additionally it is possible to add one or more further additives to the hotmelt PSAs, such as aging inhibitors, light stabilizers, ozone protectants, fatty acids, plasticizers, nucleators and/or accelerators, and also one or more fillers such as fibers, carbon black, zinc oxide, titanium dioxide, solid microbeads, silica, silicates, chalk and/or blocking-free isocyanates.

As plasticizers to be added additionally it is possible to employ all of the plasticizing substances known from adhesive tape technology. These include, among others, the paraffinic and naphthenic oils, (optionally functionalized) oligomers such as oligobutadienes and/or oligoisoprenes, liquid nitrile rubbers, liquid terpene resins, vegetable and animal oils and fats, phthalates, and functionalized acrylates.

For possible UV crosslinking it is possible to blend the PSAs advantageously with photoinitiators. Suitability for this purpose is possessed preferably by Norrish type I and type II dissociators, some examples of both classes being provided by benzophenone, acetophenone, benzil, benzoin, hydroxyalkylphenone, phenyl cyclohexyl ketone, anthraquinone, thioxanthone, triazine and/or fluorenone derivatives, this enumeration not being intended as conclusive. An overview is given in “Photoinitiation Photopolymerization and Photocuring, Fundamentals and Applications” by J. P. Fouassier (Hanser Publishers, Munich, Vienna, N.Y., 1995) and in “Chemistry and Technology of UV & EB Formulation for Coatings, Inks and Paints”, volume 5 by A. Carroy, C. Decker, J. P. Dowling, P. Pappas, B. Monroe (ed. by P.K.T. Oldring, publ. by SITA Technology, London, 1994).

The hotmelt PSAs prepared in this way are foamed in the process of the invention as a hotmelt composition. To achieve a foam it is advantageous to use any desired gas or gas mixture, preferably nitrogen, air, carbon dioxide, hydrocarbons and/or noble gases. In one preferred version inert gases are used. In some cases it is also possible for foaming by means of thermal decomposition of gas-evolving substances such as azo, carbonate and/or hydrazide compounds to prove suitable.

The degree of foaming, in other words the gas fraction, ought to amount to at least about 10% by volume and can range up to about 80%. In practice figures of 30% to 70%, preferably of approximately 50% gas fraction, have been found appropriate.

Depending on the particular field of use of the PSA, open-pored or closed-pored foams may be advantageous, and systems with both open and closed pores can also be realized. If operating at relatively high temperatures of more than 100° C. with a comparatively high internal pressure, the products are open-pored PSA foams. By varying the parameters, such as by reducing the pressure, for example, it is also possible to produce and use closed-pored foam structures.

One particularly suitable process for producing the PSA foams operates according to the so-called foam mix system. In this case the PSA is reacted under high pressure at about 120° C. with dry gases such as nitrogen, air or carbon dioxide, for example, in different volume fractions (approximately 10% to 80%) in a stator/rotor system. While the gas feed pressure is greater than 100 bar, the gas/PSA mixing pressures in the system are from 40 to 100 bar, preferably from 40 to 70 bar. The PSA pressurized in this way foams up following its emergence from a nozzle.

In principle it is possible to produce PSA foams having different structures and physical properties (including densities). Foams which have shown themselves to be particularly advantageous are those having a density of from about 2 to 500 kg/m³, very preferably from 20 to 200 kg/m³.

For the purpose of crosslinking and stabilization, directly after foaming and emergence from the nozzle—the two aforementioned steps possibly also taking place simultaneously—the PSA foam is guided onto a roll of the type described earlier, in particular a chill roll provided with a contact medium. It is preferred to use water cooled to below 5° C., whose effectiveness can be improved by adding the additives described above. The film of contact liquid on the roll compensates unevennesses in the roll surface and in the PSA foam and so prevents cavities in this area.

As a result of coating from the nozzle the PSA foams commonly possess a resilience. In this context the PSA foam contracts, for example, following emergence from the nozzle. In order to prevent this it is advantageous to vary the width of the coating nozzle and to adapt it to the desired result. Thus, for example, the nozzle width may be chosen to be well above the width of the coated layer of pressure-sensitive adhesive.

One refinement of the process of the invention provides for direct application of the PSA foam, after crosslinking, to a backing material (PP, BOPP, PET, nonwoven, PVC, polyesters, backing foams and the like) or to release paper (glassine, HDPE, LDPE or the like), or for transfer lamination.

One refinement of the process of the invention is distinguished by the fact that oriented PSA foams can be produced. For this purpose, in a preferred version of the process, PSAs having a high molecular weight are foamed and coated in accordance with the process of the invention. By means of appropriate nozzle geometry and of stretching to a low layer thickness it is possible to achieve an orientation of the PSA foam that is “frozen in” by direct cooling and immediate crosslinking with actinic radiation (electron beams, UV light and the like). Crosslinking takes place likewise on the chill roll. PSA foams of this kind have an anisotropic behavior which influences in particular the stress/strain characteristics of the PSA foam.

In the case of this procedure it is preferred to press the hotmelt PSA, during and/or after foaming, through an extrusion die, with stretching taking place, and to place the hotmelt PSA, thus foamed and stretched, onto the coolable roll.

Placement onto the roll takes place advantageously immediately after pressing through the nozzle, in other words in the form of extrusion coating.

The extrusion dies used may come from one of the three following categories: T dies, fishtail dies and coathanger dies. The individual types differ in the design of their flow channel. To produce oriented acrylate PSAs it is particularly preferred to carry out coating with a coathanger die, specifically in such a way that a polymer layer is formed on the surface by a movement of die relative to the surface to be coated—advantageously, in other words, relative to the roll surface. The orientation is maintained by the shaping of the acrylate hotmelt in the coathanger die and by its emergence from the die with a particular film thickness, by the stretching of the PSA film to a lower thickness during transfer to the surface, and by the subsequent crosslinking on the roll.

Advantageously the time between coating and crosslinking is very short, preferably not greater than 10 s.

The PSA foams produced by the process of the invention can be used outstandingly as PSAs wherever “conventional” PSAs have been employed to date, but afford improved PSA properties, such as, for example, a very good flow-on behavior and hence a significantly higher tack. Additionally the PSA foams may compensate unevennesses. Thus it is possible with advantage to use such PSA foams in particular for adhesive tapes, where the PSA may be applied to one or both sides of a backing.

Description of the Experiments Conducted

Preparation of acrylate PSA 1

A 200 L reactor conventional for free-radical polymerizations was charged with 2.4 kg of acrylic acid, 3.2 kg of N-tert-butylacrylamide, 4.0 kg of methyl acrylate, 30.4 kg of 2-ethylhexyl acrylate and 30 kg of acetone/isopropanol (97:3). After nitrogen gas had been passed through the reactor for 45 minutes with stirring the reactor was heated to 58° C. and 20 g of 2,2′-azoisobutyronitrile (AIBN) were added. Subsequently the external heating bath was heated to 75° C. and the reaction was carried out constantly at this external temperature. After a reaction time of 1 h a further 20 g of AIBN were added. The reaction was discontinued after a time of 48 h and the batch was cooled to room temperature. Subsequently the PSA was freed from solvent by heating and application of a vacuum. The residual solvent content was <0.5%.

Preparation of Acrylate PSA 2

A 200 L reactor conventional for free-radical polymerizations was charged with 3.6 kg of acrylic acid, 36.4 kg of 2-ethylhexyl acrylate and 30 kg of acetone/isopropanol (97:3). After nitrogen gas had been passed through the reactor for 45 minutes with stirring the reactor was heated to 58° C. and 20 g of 2,2′-azoisobutyronitrile (AIBN) were added. Subsequently the external heating bath was heated to 75° C. and the reaction was carried out constantly at this external temperature. After a reaction time of 1 h a further 20 g of AIBN were added. The reaction was discontinued after a time of 48 h and the batch was cooled to room temperature. Subsequently the PSA was freed from solvent by heating and application of a vacuum. The residual solvent content was <0.5%.

Coating

The acrylate hotmelts were conveyed by means of a single-screw extruder (UD: 27). Foaming took place in accordance with the above-described foam mix process at 120° C., using nitrogen in a ratio of 1:2 (ratio of PSA to nitrogen). The resultant gas fraction in the PSA foam is 50%. The PSA was reacted with nitrogen in a stator/rotor system. The gas feed pressure was greater than 100 bar. The gas/PSA mixing pressures were between at approximately 60 bar. Coating took place without contact, by means of a monoextrusion die, onto a chill roll. Foam formation occurred on emergence from the die. Following electron beam bombardment the composition was transferred via the web-guiding contact roll to a 12 pm corona-treated PET film.

Electron Beam Bombardment

Electron beam bombardment was carried out with an instrument from Electron Crosslinking AB, Halmstad, Sweden. The PSA foam for irradiation was passed over a chill roll beneath the Lenard window of the accelerator. In the zone of irradiation the atmospheric oxygen was displaced by blanketing with pure nitrogen. The web speed was 10 m/min. Crosslinking took place with an acceleration voltage of 180 kV, at 40 kGy. For the irradiated material the chill roll was provided by means of a specialty roll with a wettable surface coating. The contact liquid (water containing 5% n-butanol) was applied using an applicator. The thickness of the liquid film was about 0.01 to 0.5 mm.

1. A process for preparing a pressure-sensitive adhesive, said process comprising the following steps:
a) providing a hotmelt pressure-sensitive adhesive;
b) foaming the hotmelt pressure-sensitive adhesive to yield a foamed hotmet pressure-sensitive adhesive;
c) placing the foamed hotmelt pressure-sensitive adhesive onto a coolable roll; and
d) crosslinking the foamed hotmelt pressure-sensitive adhesive on the coolable roll by exposure to actinic radiation to yield a crosslinked pressure-sensitive adhesive foam.

2. The process as claimed in claim 1, wherein the crosslinked pressure-sensitive adhesive foam is transferred to a backing material and/or to a further pressure-sensitive adhesive layer.

3. The process as claimed in claim 1, wherein the hotmelt pressure-sensitive adhesive is based on acrylate, methacrylate, natural rubber, synthetic rubber or EVA.

4. The process as claimed in claim 1, wherein the temperature of the roll during irradiation of the hotmelt pressure-sensitive adhesive is not more than 25° C.

5. The process as claimed in claim 4, wherein the roll is actively cooled.

6. The process as claimed in claim 1, wherein during the irradiation of the hotmelt pressure-sensitive adhesive there is contact medium between the adhesive and the roll.

7. The process as claimed in claim 1, wherein the hotmelt pressure-sensitive adhesive is foamed using a gas or gas mixture.

8. The process as claimed in claim 1, wherein the foaming of the hotmelt pressure-sensitive adhesive is achieved by decomposition of gas-evolving substances.

9. The process as claimed in claim 8, wherein the gas-evolving substances are azo, carbonate and/or hydrazide compounds.

10. The process as claimed in claim 1, wherein during and/or after foaming, the hotmelt pressure-sensitive adhesive is pressed through an extrusion die with stretching taking place, and the hotmelt pressure-sensitive adhesive, thus foamed and stretched, is placed onto the coolable roll.

11. The process as claimed in claim 7, wherein the gas or gas mixture comprises at least one of air, nitrogen, carbon dioxide, gaseous hydrocarbons, noble gases.

12. The process as claimed in claim 8, wherein the decomposition of the gas-evolving substances is achieved by thermal decomposition.

13. The process as claimed in claim 10, wherein the extrusion die is a coathanger die.
